(19) United States
(12) Patent Application Publication
(10) Pub. No.: US 2024/0328228 A1
(43) Pub. Date: Oct. 3, 2024

(54) WINDOW ACTUATOR LINKAGE ASSEMBLY FOR ALIGNMENT ADJUSTMENT AT A MOVEABLE PORTION OF A WINDOW

(71) Applicants: Elizabeth Galvin, Washington, DC (US); ABT Systems, LLC, Annville, PA (US); TM Rudd Consulting, LLC, Lacona, NY (US)

(72) Inventors: Armin F. Rudd, Annville, PA (US); Timothy M. Rudd, Lacona, NY (US)

(21) Appl. No.: 18/129,480

(22) Filed: Mar. 31, 2023

(51) Int. Cl. E05F 15/00

(52) U.S. Cl. CPC E05F 15/00; E05Y 2201/43; E05Y 2201/656; E05Y 2600/12; E05Y 2600/14; E05Y 2600/31; E05Y 2600/46; E05Y 2600/51; E05Y 2600/61; E05Y 2600/626; E05Y 2900/148

(57) ABSTRACT

A window actuator linkage assembly that includes barrel brackets, a mounting bracket, and a clamping plate for fastening to a moveable portion of a window that facilitates adjustment of the alignment of a chain extending from an actuator positioned on or within a fixed portion of a window to the window actuator linkage assembly. A window actuator linkage assembly can also include elements such as barrel brackets that have openings to receive a fastener, a T-shaped base, and a slotted base bracket having an inner surface that slidably engages with the T-shaped base, and is configured to fix the T-shaped base in a desired position along the length of the slotted base bracket.

### FIELD OF THE INVENTION

Embodiments of the present invention relate to a window actuator linkage assembly having barrel brackets, a mounting bracket, and a clamping plate and, more particularly, to a window actuator linkage assembly on a moveable portion of the window that facilitates adjustment of the alignment of a chain extending from a fixed portion of the window to the moveable portion of the window.

### BACKGROUND

As referred to in this document, a window is an opening constructed in a wall, door, or roof for the purpose of admitting light or air to a space within a building enclosure and is framed and spanned with glass mounted to permit opening and closing.

Windows in buildings can be installed with motorized actuators for convenience of opening and closing the moveable portion of the window, without having physical human contact with the window. The actuator can be mounted on an exposed fixed surface of a window frame or mounted unexposed and recessed into the fixed frame part of the window. The actuator utilizes a conventional push-pull chain or similar chain (hereinafter “chain” or “actuator chain”), such as described in U.S. Pat. No. 8,250,846, that can bend in one direction only and thus allows the chain to push a load, and to thus open and close the moveable portion of the window. U.S. Pat. No. 8,250,846 is incorporated herein by reference in its entirety.

One end of the chain is connected to a window chain linkage on the moveable portion of the window, and the other end of the chain is connected to an actuator chain linkage of the actuator. The chain is driven by an actuator motor, which causes the chain to extend from the actuator and retract into the actuator, to thereby respectively open and close the window.

Difficulties can arise in obtaining proper mounting alignment between the actuator chain linkage—when the actuator is either mounted on or recessed into the fixed portion of the window—and the window chain linkage, particularly when the actuator is mounted unexposed and recessed into the fixed frame part of a window. Even relatively small misalignments between the ends of the chain proximate the actuator chain linkage and the window chain linkage can cause binding of the actuator chain such that moveable portion of the window may not close properly.

Misalignments can be caused by conditions such as imprecise surface mounting of the actuator, imprecise machining of the concealed recess within the window frame, slightly out of square moveable portions of the window, slightly out of plumb or level window frame installation, and/or window component movement caused by thermal expansion and contraction. The relatively small tolerances required for proper operation make issues caused by slight misalignment common.

When the moveable portion of the window does not close properly and contact the window seals, water, air and noise intrusion can occur, and security can be compromised. Attempts to resolve misalignment between the actuator chain linkage and the window chain linkage, such as by remounting the actuator or attempting in-place machining of the actuator linkage on the moveable portion of the window, can be time consuming and costly, and may not effectively correct the misalignment.

Misalignment between the window chain linkage and the actuator chain linkage can be further complicated when, for example, large windows utilize multiple actuators. Under such circumstances, one actuator may not pull the window closed fully while the other actuator does, thereby causing a potentially dangerous out-of-plane bending force to be applied to the moveable portion of the window that could potentially cause the glass to break, especially in the presence of thermal stresses due to indoor to outdoor temperature differences.

### SUMMARY OF EMBODIMENTS OF THE INVENTION

In a first embodiment, an actuator linkage assembly is provided for mounting on a moveable portion of a window. The assembly includes a first barrel bracket that has a first opening, a second barrel bracket that has a second opening, such that the first and second barrel brackets are capable of being arranged to have a window chain linkage having a third opening positioned between the first and second barrel brackets so that the first, the second and the third openings are in substantial axial alignment to receive a fastener for insertion into the first, second and third openings. The first barrel bracket comprises a first hole and the second barrel bracket comprises a second hole to respectively receive a first fastener and a second fastener.

In addition, a mounting bracket includes a first surface, a second surface and a third surface, such that the first and second surfaces have a first slot and a second slot, and the second and third surfaces form a channel, such that at least a portion of the first barrel bracket and at least a portion of the second barrel bracket contact at least a portion of the first surface of the mounting bracket. The first and second barrel brackets respectively include first and second extended portions that respectively fit into and slidingly engage along the first and second slots, and the first and second extended portions respectively include a first hole and a second hole to respectively receive the first fastener and the second fastener.

A clamping plate is positioned within the channel and is in contact with the second surface of the mounting bracket. The clamping plate has a first hole and a second hole capable of respectively receiving the first fastener and the second fastener, such that the first barrel bracket is capable of being positioned along the first slot and secured in place by tightening the first fastener, and the second barrel bracket is capable of being positioned along the second slot and secured in place by tightening the second fastener, such that positioning the first and second barrel brackets allows an actuator chain to be aligned along its length, from a fixed part of the window to the window chain linkage.

The respective first holes of the first barrel bracket, the first extended portion, and the clamping plate, and the first slot of the bracket can be positioned in substantial alignment to receive the first fastener, and the respective second holes of the second barrel bracket, the second extended portion, and the clamping plate, and the second slot of the bracket can be positioned in substantial alignment to receive the second fastener.

The first and second holes of the clamping plate are threaded. In addition, the first and second barrel brackets are capable of being secured in position when the first and second fasteners are tightened. The first and second slots can be oblong.

The bracket can include a first hole configured to receive the first fastener and a second hole configured to receive the second fastener, for mounting the actuator linkage assembly to the moveable portion of the window. The actuator linkage assembly is capable of being configured to facilitate rotation of the moveable portion of the window, from a first position to a second position. In addition, the actuator linkage assembly is capable of being further configured to facilitate opening and closing the moveable portion of the window. The fastener can be a pin.

The first and second oblong slots can be positioned equidistant from a midpoint of the bracket. In addition, the actuator linkage assembly is capable of being configured to have a motor of an actuator facilitate extending and retracting the actuator chain to cause rotation of the moveable portion of the window, from a first position to a second position. The first fastener and the second fastener can be a bolt.

In a second embodiment, an actuator linkage assembly is provided for mounting on a moveable portion of a window. The assembly includes a first barrel bracket that has a first opening, a second barrel bracket that has a second opening, such that the first and second barrel brackets are capable of being arranged to have a window chain linkage having a third opening positioned between the first and second barrel brackets so that the first, the second and the third openings are in substantial axial alignment to receive a fastener for insertion into the first, second and third openings. In addition, a mounting bracket includes a first surface, a second surface and a third surface, such that the first and second surfaces have a first slot and a second slot, and the second and third surfaces form a channel, such that at least a portion of the first barrel bracket and at least a portion of the second barrel bracket contact at least a portion of the first surface of the mounting bracket.

A clamping plate is positioned within the channel and is in contact with the second surface of the mounting bracket. The clamping plate has a first hole that is configured to receive a first fastener that is inserted through a hole of the first barrel bracket and the first slot, and a second hole that is configured to receive a second fastener inserted through a hole of the second barrel bracket and the second slot, such that the first barrel bracket is capable of being positioned along the first slot and the second barrel bracket is capable of being positioned along the second slot, and positioning the first and second barrel brackets allows an actuator chain to be aligned along its length, from a fixed part of the window to the window chain linkage.

The first and second barrel brackets can include an extended portion that respectively fits into the first and second slots, which can be oblong slots. The first and second barrel brackets are capable of being secured in position when the first and second fasteners are tightened.

The bracket can include a first hole that is configured to receive the first fastener and a second hole configured to receive the second fastener, for mounting the assembly to the moveable portion of the window. The first fastener can be a screw, and the second fastener can also be a screw.

The assembly is capable of being configured to facilitate rotation of the moveable portion of the window, from a first position to a second position, and doing so without binding the actuator chain. The assembly is also capable of being further configured to facilitate opening and closing the moveable portion of the window, and doing so without binding the actuator chain.

The fastener for insertion into the first, second and third openings can be a pin, and the first and second oblong slots can be positioned equidistant from a midpoint of the bracket. The assembly is also capable of being configured to have a motor of an actuator facilitate extending and retracting the actuator chain that is secured to the window chain linkage, to cause rotation of the moveable portion of the window, from a first position to a second position.

The actuator chain linkage assembly is further capable of being configured to be driven by an actuator motor of an actuator mounted on or within the fixed portion of the window, which causes the actuator chain to extend from the actuator and retract into the actuator, to thereby rotate the moveable portion of the window, from a first position to a second position.

In a third embodiment, a method for making an actuator linkage assembly is provided such that the assembly can be mounted on a moveable portion of a window and in a manner that is suitable for use to align a chain of an actuator along a length of the chain between a fixed part of a window and a moveable portion of the window. The method includes providing for use on the moveable portion of the window a first barrel bracket that includes a first opening and providing for use on the moveable portion of the window a second barrel bracket that includes a second opening, wherein said first and second barrel brackets are capable of being arranged to have a window chain linkage that has a third opening and that is connected to the chain and that is positioned between the first and second barrel brackets. The first, second and third openings are capable of receiving a fastener for insertion into the first, second and third openings.

The method also includes providing a mounting bracket that has a first surface and a second surface that respectively have a first slot and a second slot, wherein at least a portion of the first barrel bracket and at least a portion of the second barrel bracket are capable of being positioned to contact at least a portion of the first surface. The method further includes providing a clamping plate capable of being positioned within a channel of the mounting bracket and in contact with the second surface. The clamping plate is provided with a first hole that is configured to receive a first fastener inserted through a hole of the first barrel bracket and the first slot, and a second hole that is configured to receive a second fastener inserted through a hole of the second barrel bracket and the second slot, so that the chain is capable of being maintained in alignment along its length, from the fixed part of the window to the window chain linkage, upon mounting the bracket to the moveable portion of the window and securing the first barrel bracket along the first slot and securing the second barrel bracket along the second slot by respectively tightening the first and second fasteners. The first and second holes of the clamping plate can be threaded.

The method can also include providing on the first and second barrel brackets an extended portion that respectively fits into the first and second slots, each of which can be oblong and positioned equidistant from a midpoint of the bracket. The method can also include providing the mounting bracket with a first hole configured to receive a first fastener and a second hole configured to receive a second fastener, for mounting the assembly to the moveable portion of the window.

In addition, the assembly can be provided with the capability of being configured to facilitate rotation of the moveable portion of the window, from a first position to a second position, and doing so without binding the actuator chain. The first and second positions can correspond to the window respectively being in an opened position and being in a closed position, and being rotated to opened and closed positions without binding the actuator chain.

The method can further include providing a pin as the fastener for insertion into the first, second and third openings. The method can also include providing the assembly with the capability of being configured to have a motor facilitate extending and retracting the actuator chain to cause rotation of the moveable portion of the window, from a first position to a second position. The first and second positions can correspond to the window respectively being in an opened position and being in a closed position, and being rotated to opened and closed positions without binding the actuator chain. A first screw can be provided as the first fastener, and a second screw can be provided as the second fastener.

The method can also include providing the assembly with the capability of being configured to be driven by a motor of an actuator mounted on or within the fixed portion of the window, which causes the actuator chain to extend from the actuator and retract into the actuator, to thereby rotate the moveable portion of the window, from a first position to a second position. The method can further include providing the mounting bracket with a first hole configured to receive a first fastener and a second hole configured to receive a second fastener for mounting the assembly to the moveable portion of the window

In a fourth embodiment, a method is provided for connecting an actuator chain that extends from a fixed part of a window to a moveable portion of the window. The method includes providing for use on the moveable portion of the window a first barrel bracket that has a first opening, and also providing for use on the moveable portion of the window a second barrel bracket that has a second opening.

The first and second barrel brackets are capable of being arranged to have a window chain linkage, connected to the chain and having a third opening, capable of being positioned between the first and second barrel brackets, wherein the first, second and third openings are capable of receiving a fastener for insertion into the first, second and third openings. The method also includes providing a bracket that has a first surface and a second surface, such that the first and second surfaces respectively include a first slot and a second slot, wherein at least a portion of the first barrel bracket and at least a portion of the second barrel bracket are capable of being positioned to contact at least a portion of the first surface, whereby positioning the first and second barrel brackets allows an actuator chain to be aligned along its length, from the fixed part of the window to the window chain linkage.

The method further includes providing a clamping plate that is capable of being positioned within a channel of the mounting bracket and that is in contact with the second surface. In addition, the clamping plate includes a first hole that is configured to receive a first fastener inserted through a hole of the first barrel bracket and the first slot, and a second hole that is configured to receive a second fastener inserted through a hole of the second barrel bracket and the second slot, wherein the first barrel bracket is capable of being secured along the first slot and the second barrel bracket is capable of being secured along the second slot, by respectively tightening the first and second fasteners.

The method also includes providing the chain with the capability of being maintained in alignment along its length, from the fixed part of the window to the window chain linkage, upon securing the first barrel bracket along the first slot and securing the second barrel bracket along the second slot by respectively tightening the first and second fasteners. In addition, the method includes providing on the first and second barrel brackets an extended portion that respectively fits into the first and second slots, each of which can be oblong.

The method further includes providing the mounting bracket with a first hole configured to receive a first fastener and a second hole configured to receive a second fastener, for mounting the bracket to the moveable portion of the window. A first screw can be provided as the first fastener and a second screw can be provided as the second fastener. The first and second brackets can be provided with the capability of being configured to facilitate rotation of the moveable portion of the window, from a first position to a second position, and doing so without binding the actuator chain.

In addition, the assembly can be provided with the capability of being configured to facilitate opening and closing the moveable portion of the window, and doing so without binding the actuator chain. The provided fastener can be a pin, and the first and second oblong slots can be positioned equidistant from a midpoint of the bracket.

The method also includes providing the actuator chain linkage assembly with the capability of being configured to be driven by an actuator motor of an actuator mounted on or within the fixed portion of the window, to cause the actuator chain to extend from the actuator and retract into the actuator, to thereby rotate the moveable portion of the window, from a first position to a second position.

The method can also include providing the assembly with the capability of being configured to have a motor facilitate extending and retracting the actuator chain to cause rotation of the moveable portion of the window, from a first position to a second position. In addition, the provided first and second barrel brackets can be capable of being secured in position along the bracket when the first and second fasteners are tightened. The first and second holes of the clamping plate can be threaded.

In a fifth embodiment, a window actuator linkage assembly for mounting on a moveable portion of a window is provided. The assembly includes an elongate mounting member having a first barrel bracket and a second barrel bracket separated from the first barrel bracket by an opening along a length of the elongate mounting member, and a base portion having i) a bottom surface portion, ii) a first side surface portion extending substantially perpendicular from the bottom surface portion, iii) a first return surface extending substantially perpendicular from the first side surface portion, iv) a first shoulder extending substantially perpendicular from the first return surface, v) a second side surface portion extending substantially perpendicular from the bottom surface portion and substantially parallel to the first side surface portion, vi) a second return surface extending substantially perpendicular from the second side surface, and vii) a second shoulder extending substantially perpendicular from the second return surface and substantially parallel to the first shoulder, wherein a width of the bottom surface portion defined by the first and second side surface portions is greater than a width of the first and second barrel brackets.

The assembly also includes an elongate base bracket, formed separately from and configured to be secured to the elongate mounting member, having i) an inner surface and an outer surface, ii) a first wall extending substantially perpendicularly from and along a first edge of the inner surface, terminating at a first wall edge distal from the first edge of the inner surface, iii) a second wall projecting substantially perpendicularly from and along a second edge of the inner surface and substantially parallel to the first wall, terminating at a second wall edge distal from the second edge of the inner surface, iv) a first return portion extending from the first wall edge and substantially towards the second wall, and v) a second return portion extending from the second wall edge and substantially towards the first wall, such that the first side surface portion is configured to be slidably positioned along the first wall and the first return surface is configured to be slidably positioned along the first return portion, and such that the second side surface portion is configured to be slidably positioned along the second wall and the second return surface is configured to be slidably positioned along the second return portion.

The base portion includes at least one hole, which can be configured to receive a screw to fasten barrel brackets in a desired position along the length of the elongate base bracket. The base portion can also include at least two holes, each of which can be configured to respectively receive a screw to fasten the first and second barrel brackets in a desired position along the length of the elongated base bracket. In addition, the elongate base bracket can include at least two screw holes, each of which can be configured to respectively receive a screw to fasten the elongate base bracket to the moveable portion of the window.

In addition, the opening along the length of the elongate mounting member is configured to receive a window chain linkage of an actuator. The window chain linkage includes a third opening, such that the first, second and third openings are capable of receiving a fastener for insertion into the first, second and third openings.

### BRIEF DESCRIPTION OF THE DRAWINGS

FIG. 1 is an isometric top view of a first embodiment of a linkage assembly.

FIG. 2A is a top view of an exemplary bracket when the barrel brackets of the linkage assembly include barrel bracket extensions, as shown in FIG. 4A.

FIG. 2B is a bottom view of an exemplary bracket when the barrel brackets of the linkage assembly include barrel bracket extensions, as shown in FIG. 4A.

FIG. 2C is a bottom perspective view of an exemplary bracket when the barrel brackets of the linkage assembly include barrel bracket extensions, as shown in FIG. 4A.

FIG. 2D is a top view of an exemplary bracket when the barrel brackets of the linkage assembly do not include barrel bracket extensions, as shown in FIG. 4B.

FIG. 2E is a bottom view of an exemplary bracket when the barrel brackets of the linkage assembly do not include barrel bracket extensions, as shown in FIG. 4B.

FIG. 2F is a bottom perspective view of an exemplary bracket when the barrel brackets of the linkage assembly do not include barrel bracket extensions, as shown in FIG. 4B.

FIG. 3 is a top view of an exemplary clamping plate.

FIG. 4A is an isometric bottom view of a linkage assembly that utilizes barrel bracket extensions.

FIG. 4B is an isometric bottom view of a linkage assembly that does not utilize barrel bracket extensions.

FIG. 5A is a partial cut-away view of FIG. 1, along line 5-5 that includes barrel bracket extensions.

FIG. 5B shows a view of FIG. 5A that does not include barrel bracket extensions.

FIG. 6 is a front view of FIG. 1.

FIG. 7 is a top view of FIG. 1, with section line 10-10.

FIG. 8 is a bottom view of FIG. 1.

FIG. 9 is an end view of FIG. 1, looking along arrowed line 9 of FIG. 1.

FIG. 10A is a front and partial sectional view of FIG. 7, along line 10-10 of FIG. 7.

FIG. 10B is an isometric bottom view of FIG. 7, taken along line 10-10 of FIG. 7.

FIG. 10C is a view of FIG. 10A, without the barrel bracket extension shown in FIG. 10A.

FIG. 10D is a view of FIG. 10B, without the barrel bracket extension shown in FIG. 10B.

FIG. 11 is an isometric view of an assembly of an interior side of a window in a section of wall.

FIG. 12 is an elevation view of FIG. 11, viewed along arrow 12.

FIG. 13 is a magnified view of a portion of FIG. 12.

FIG. 14 is an isometric view of FIG. 11, rotated clockwise, showing the exterior side.

FIG. 15 is a close-up of the detail marked XV in FIGS. 11-14.

FIG. 16A is an isometric top view of a second embodiment of a linkage assembly.

FIG. 16B is an isometric bottom view of a second embodiment of a linkage assembly.

FIG. 16C is a front view of FIG. 16A.

FIG. 16D is a top view of FIG. 16A, with section line G-G.

FIG. 16E is a bottom view of FIG. 16B.

FIG. 16F is an end view of FIG. 16A, looking along arrowed line 16 of FIG. 16A.

FIG. 16G is a second isometric top view of the second embodiment of the linkage assembly.

FIG. 16H is a cross sectional view of FIG. 16G along line G-G of FIG. 16D.

FIG. 17A is a top perspective view of a second embodiment of barrel brackets.

FIG. 17B is a bottom perspective view of the barrel brackets of FIG. 17A.

FIG. 17C is a top view of FIG. 17A.

FIG. 17D is a bottom view of FIG. 17B.

FIG. 17E is an end view of FIG. 17A, looking along arrowed line 17 of FIG. 17A.

FIG. 18A is an isometric top view of an exemplary T-slot base bracket.

FIG. 18B is an isometric bottom view of an exemplary T-slot base bracket.

FIG. 18C is a top view of FIG. 18A.

FIG. 18D is a bottom view of FIG. 18B.

FIG. 18E is an end view of an exemplary T-slot base bracket of FIG. 18A, looking along arrowed line 18 of FIG. 18A.

### DETAILED DESCRIPTION OF EMBODIMENTS

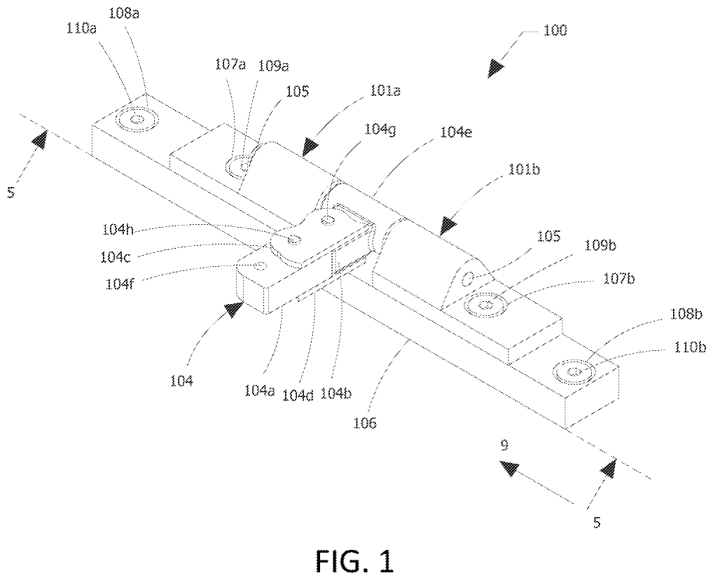

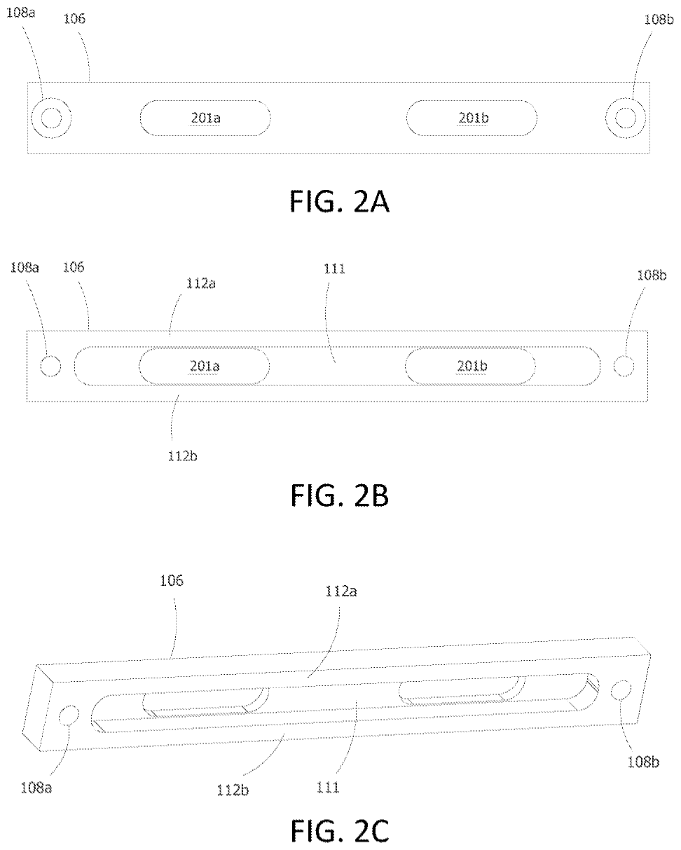

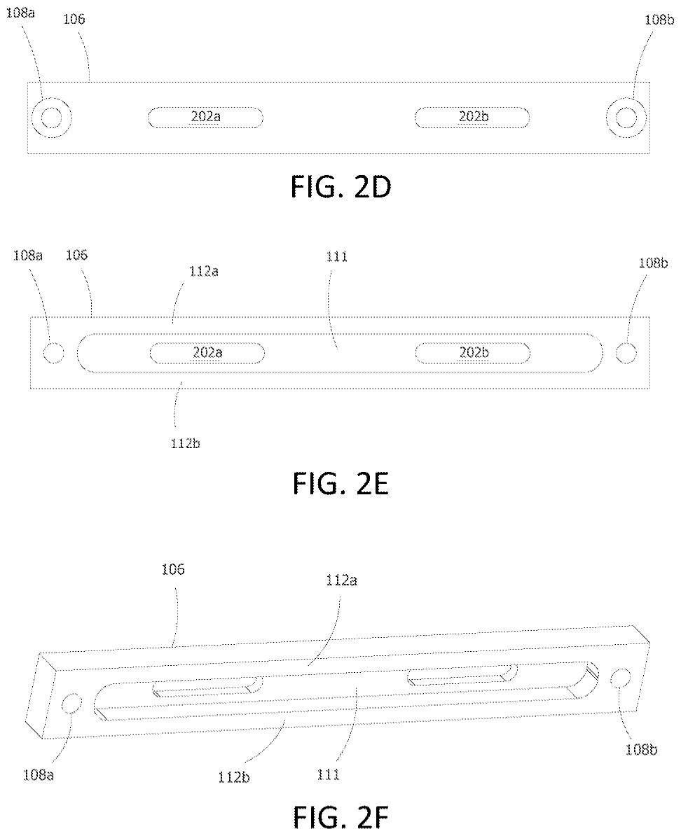

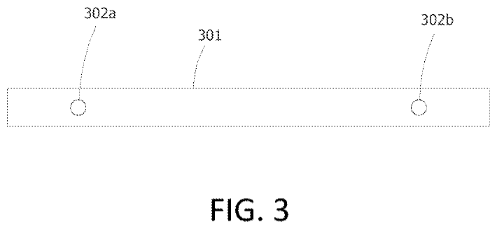

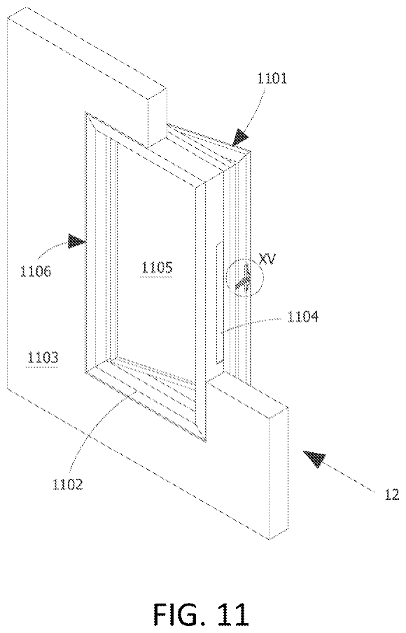

FIG. 1 is an isometric top view of a first embodiment of an actuator linkage assembly 100 used to connect an actuator chain 104 from a window actuator 1104 (shown in FIG. 11) to a movable portion 1101 of a window 1106 (shown in FIG. 11). Generally, the actuator linkage assembly 100 includes elements such as a barrel brackets 101a, 101b, a bracket 106 having a channel 111 between two legs 112a, 112b (shown in FIGS. 2B and 2C), and a clamping plate 301 (shown in FIG. 3), as described further below.

A conventional window actuator 1104 (such as the KIMO 202 model by Nekos SRL, Colceresa (VI), Italy) having a conventional push-pull actuator chain 104, can be used to open and close the movable portion 1101 of window 1106, without having direct physical human contact with the window. The actuator chain 104 includes, for example, inner plates 104a, 104b, outer plates 104c, 104d, window chain linkage 104e, pinhole 104f, and pins 104g, 104h, which are conventional and part of the KIMO 202 actuator.

Barrel brackets 101a, 101b are separated by a space into which the window chain linkage 104e is positioned. When window chain linkage 104e is positioned between the barrel brackets 101a, 101b, the window chain linkage 104e and barrel brackets 101a, 101b are kept in alignment by a fastener 105, such as a screw or pin, that is inserted through the respective openings, such as a conventional bore hole, of the first barrel bracket 101a, the window chain linkage 104e, and the second barrel bracket 101b, such as in an analogous manner to the two leaves of a door hinge and the hinge pin that holds them together. Barrel brackets 101a, 101b respectively include screw holes 107a, 107b. Fasteners, such as screws 109a, 109b, are inserted through screw holes 107a, 107b to respectively fasten barrel brackets 101a, 101b to desired locations along the length of bracket 106, as explained further herein. Screws 110a, 110b are respectively inserted into screw holes 108a, 108b and tightened to secure the actuator linkage assembly 100 to a moveable portion 1101 of window 1106, as shown, for example, in FIG. 11.

FIG. 2A is a top view of an exemplary bracket 106, FIG. 2B is a bottom view of an exemplary bracket 106, and FIG. 2C is a bottom perspective view of an exemplary bracket 106. In an embodiment, the bracket 106 has two oblong slotted holes 201a, 201b, which can be equidistant from a midpoint along the length of the bracket 106. Screw 109a is inserted through screw hole 107a of barrel bracket 101a and through oblong slotted hole 201a in the bracket 106. Similarly, screw 109b is inserted through screw hole 107b of barrel bracket 101b and through oblong slotted hole 201b of the bracket 106. Barrel brackets 101a, 101b can be positioned along the length of oblong slotted holes 201a, 201b. At least a portion of the bottom surface of each barrel bracket 101a, 101b is in direct (or indirect) contact with a top surface of the bracket 106. Thus, barrel brackets 101a, 101b can respectively be positioned along a length of oblong slotted holes 201a, 201b such that at least a portion of the top surface of the bracket 106 directly (or indirectly) contacts at least a portion of the bottom surface of barrel brackets 101a, 101b.

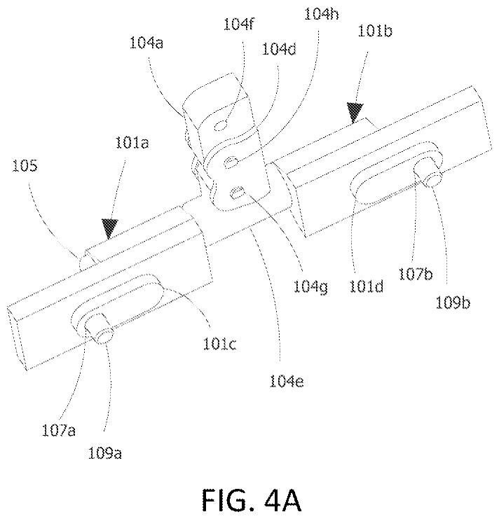

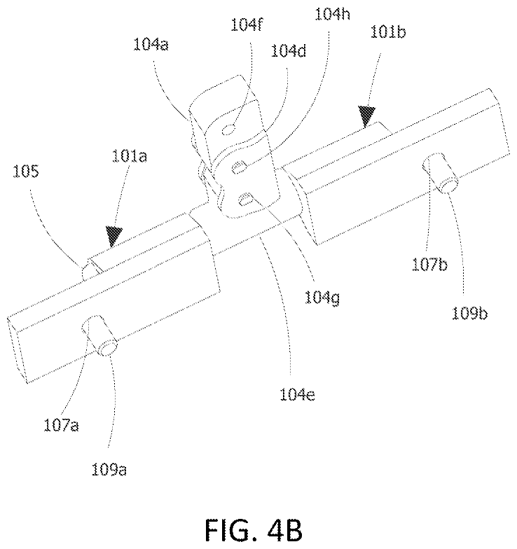

FIG. 2D is a top view of an exemplary bracket 106 when the barrel brackets 101a, 101b of the linkage assembly 100 do not include barrel bracket extensions 101c, 101d, as shown in FIG. 4B. FIG. 2E is a bottom view of an exemplary bracket 106 when the barrel brackets 101a, 101b of the linkage assembly 100 do not include barrel bracket extensions 101c, 101d, as shown in FIG. 4B. FIG. 2F is a bottom perspective view of an exemplary bracket 106 when the barrel brackets 101a, 101b of the linkage assembly 100 do not include barrel bracket extensions 101c, 101d, as shown in FIG. 4B.

In an embodiment, the bracket 106 has two oblong slotted holes 202a, 202b, which can be equidistant from a midpoint along the length of the bracket 106. Generally, slotted holes 202a, 202b will have a smaller transverse width than the corresponding transverse width of slotted holes 201a, 201b, because slotted holes 202a, 202b can be sized to accommodate the diameter of screws 108a, 108b, whereas slotted holes 201a, 201b are sized to accommodate the relatively larger transverse width of bracket extensions 101c, 101d that are used with barrel bracket extensions 101c, 101d.

In FIGS. 2D-2F, screw 109a is inserted through screw hole 107a of barrel bracket 101a and through oblong slotted hole 202a in the bracket 106. Similarly, screw 109b is inserted through screw hole 107b of barrel bracket 101b and through oblong slotted hole 202b of the bracket 106. Thus, barrel brackets 101a, 101b can respectively be positioned along a length of oblong slotted holes 202a, 202b such that at least a portion of the top surface of the bracket 106 directly (or indirectly) contacts at least a portion of the bottom surface of barrel brackets 101a, 101b.

FIG. 3 is a top view of an exemplary clamping plate 301 that fits into and is positioned within the channel 111 of the bracket 106. Clamping plate 301 has threaded holes 302a, 302b. Screw 109a, which is inserted through screw hole 107a of barrel bracket 101a and through oblong slotted hole 201a in the bracket 106, threads into threaded screw hole 302a. Similarly, screw 109b, which is inserted through screw hole 107b of barrel bracket 101b and through oblong slotted hole 201b in the bracket 106, threads into threaded screw hole 302b. Thus, at least a portion of the top surface of the clamping plate 301 is in direct (or indirect) contact with at least a portion of the bottom surface of the bracket 106.

FIG. 4A is an isometric bottom view of a first embodiment of actuator linkage assembly 100. FIG. 4A shows barrel bracket extensions 101c, 101d, which can optionally be respectively provided as part of barrel brackets 101a, 101b. Barrel bracket extensions 101c, 101d, respectively fit into and slidably engage within oblong slotted holes 201a, 201b. The length of barrel bracket extensions 101c, 101d can be sized to provide a desired range of movement, with longer extensions 101c, 101d providing a more limited range of movement, and shorter extensions 101c, 101d providing a wider range of movement within oblong slotted holes 201a, 201b. The thickness of barrel bracket extensions 101c, 101d is preferably the same as or slightly less that the thickness of oblong slotted holes 201a, 201b.

When barrel bracket extensions 101c, 101d are utilized, screw 109a is inserted through screw hole 107a, which extends through barrel bracket 101a and barrel bracket extension 101c, and is threaded into threaded screw hole 302a of clamping plate 301. Similarly, screw 109b is inserted through screw hole 107b, which extends through barrel bracket 101b and barrel bracket extension 101d, and is threaded into threaded screw hole 302b of clamping plate 301. Screw holes 107a, 107b are preferably unthreaded.

FIG. 4B shows barrel brackets 101a, 101b without the respective barrel bracket extensions 101c, 101d. FIG. 4B also shows how the screw holes 302a, 302b of clamping plate 301 align with the screw holes 107a, 107b of barrel brackets 101a, 101b. When barrel bracket extensions 101c, 101d are not utilized, screw 109a is inserted through screw hole 107a, which extends through barrel bracket 101a and barrel bracket extension 101c, and is threaded into threaded screw hole 302a of clamping plate 301. Similarly, screw 109b is inserted through screw hole 107b, which extends through barrel bracket 101b and barrel bracket extension 101d, and is threaded into threaded screw hole 302b of clamping plate 301. Screw holes 107a, 107b are preferably unthreaded.

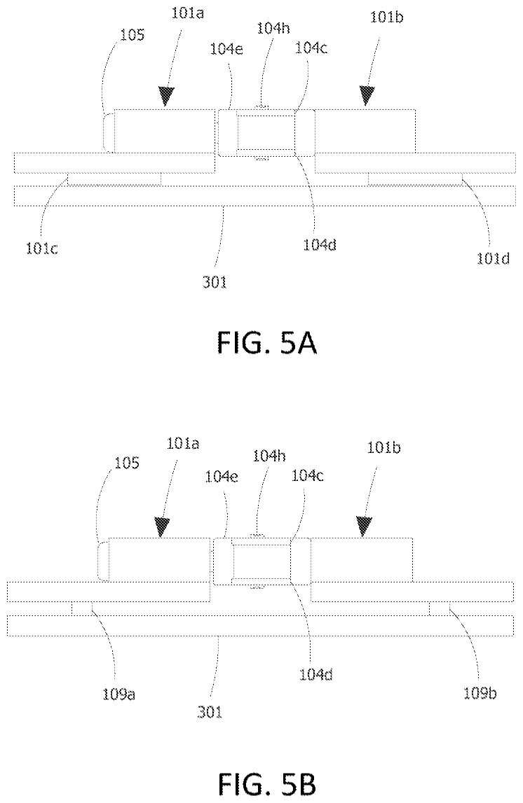

FIG. 5A is a partial cutaway view of FIG. 1 along line 5-5 (omitting bracket 106), showing barrel bracket extensions 101c, 101d and clamping plate 301 in an exemplary position. FIG. 5B shows a view of FIG. 5A that does not include barrel bracket extensions 101c, 101d, while showing clamping plate 301 and screws 109a, 109b. When screws 109a, 109b are tightened in threaded screw holes 302a, 302b, the clamping plate 301 will come into contact with at least a portion of the bottom surface of the bracket 106.

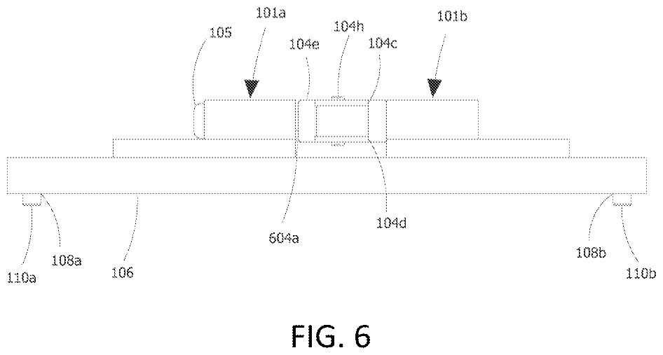

FIG. 6 is a front view of FIG. 1. Screws 110a, 110b are shown extending through screw holes 108a, 108b of bracket 106 to secure the bracket 106, for example, to the movable portion 1101. In addition, barrel brackets 101a, 101b can also be sized to provide a clearance 604a between barrel bracket 101a and window chain linkage 104e in order to allow the window chain linkage 104e to freely rotate about the fastener 105. As the clearance 604a also allows the window chain linkage 104e to slide horizontally along fastener 105, an analogous clearance 604b (not shown) may also appear between barrel bracket 101b and window chain linkage 104e, in addition to or in lieu of clearance 604a. Generally, clearances 604a, 604b will appear when window chain linkage 104e is not in contact with either barrel bracket 101a or barrel bracket 101b.

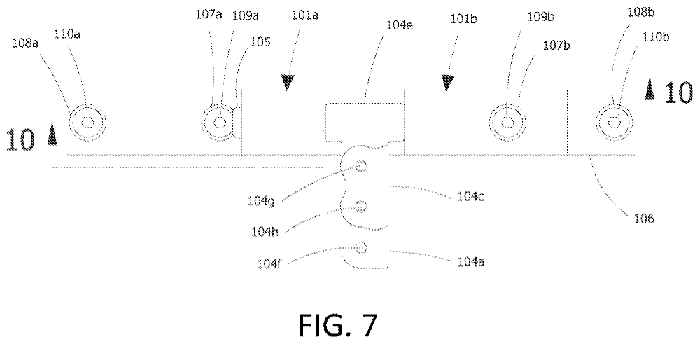

FIG. 7 is a top view of FIG. 1, with section line 10-10. FIGS. 1 and 7 will be discussed together. An end of actuator chain 104 includes, for example, inner plates 104a, 104b, outer plates 104c, 104d, window chain linkage 104e, pinhole 104f, and pins 104g, 104h, which are typically provided as part of a conventional actuator. An opposing end of actuator chain 104 is secured internally within the actuator 1104 (shown in FIG. 11) to operably connect the chain 104 to the motor of actuator 1104. Pin 104g extends through one end of outer plate 104c to secure outer plate 104c to an extending portion of window chain linkage 104e. Elements analogous to inner plates 104a, 104b, outer plates 104c, 104d, pinhole 104f, pins 104g, and an actuator chain linkage (not shown) similar to window chain linkage 104e, are also typically provided as part of a conventional actuator, and are positioned at the opposing end of chain 104.

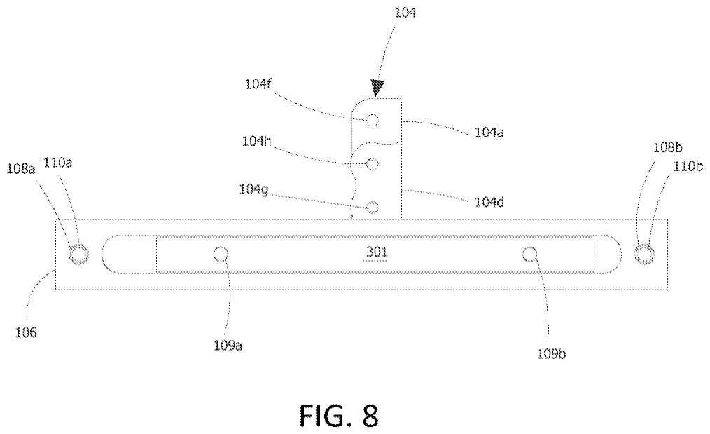

FIG. 8 is a bottom view of FIG. 1. Screws 109a, 109b are shown extending through screw holes 107a, 107b (not shown) of clamping plate 301 to secure the barrel brackets 101a, 101b and clamping plate 301 to bracket 106. Screws 110a, 110b are shown extending through screw holes 108a, 108b, to secure the linkage assembly 100 to the movable portion 1101 of window 1106.

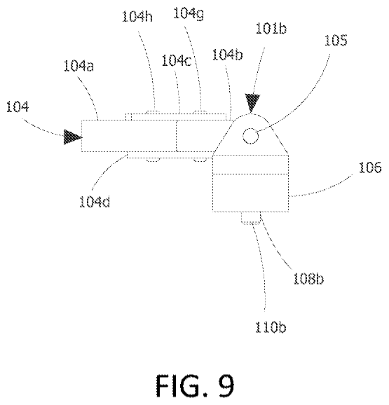

FIG. 9 is an end view of FIG. 1, looking along arrowed line 9 of FIG. 1. Screw 110b is shown extending through screw hole 108b of bracket 106 to secure the bracket 106, for example, to the movable portion 1101 of window 1106.

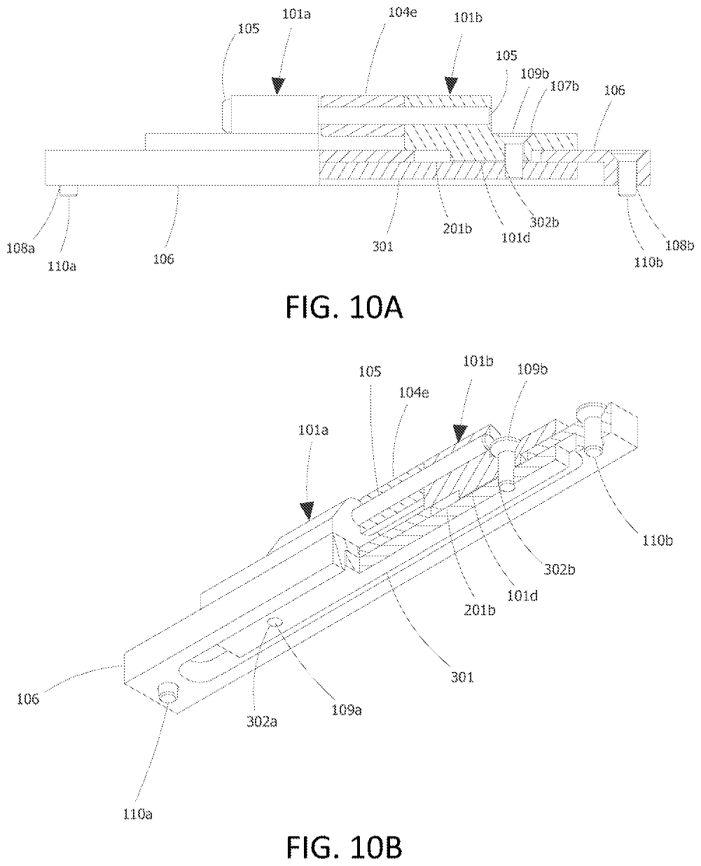

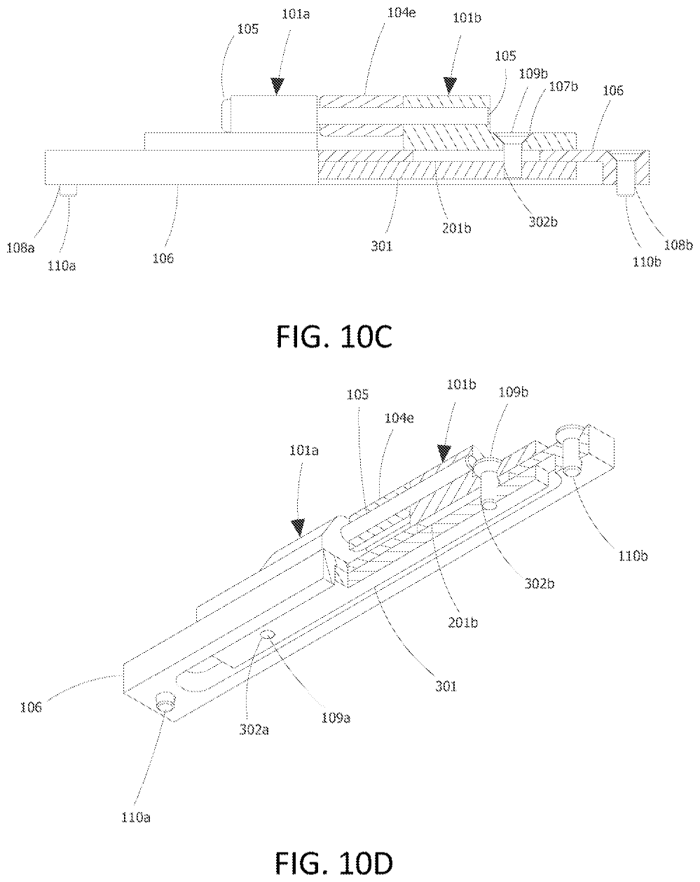

FIG. 10A is a front and partial sectional view of FIG. 1, along line 10-10 of FIG. 7, and FIG. 7B is an isometric bottom view of FIG. 1, along line 10-10 of FIG. 7. Barrel brackets 101a, 101b can be positioned along the oblong slotted holes 201a, 201b of bracket 106 while the screws 109a, 109b are loose, to allow for desired positioning of the barrel brackets 101a, 101b and clamping plate 301 along the oblong slotted holes 201a, 201b in the bracket 106, to achieve good alignment of the actuator chain 104 generally, and to position window chain linkage 104e to facilitate proper closure of the moveable portion 1101 of window 1106 without binding of the window chain 104 and window chain linkage 104e as they retract into actuator 1104. Barrel brackets 101a, 101b are secured in position along the bracket 106 when the screws 109a, 109b are turned and respectively tightened by the threaded screw holes 302a, 302b of clamping plate 301. Screws 110a, 110b are respectively inserted into screw holes 108a, 108b and tightened to secure the actuator linkage assembly 100 to a moveable portion 1101 of window 1106, as shown, for example, in FIG. 10.

FIG. 10C is a view of FIG. 10A, without the barrel bracket extension 101d shown in FIG. 10A. In FIG. 10C, screw 109b extends through screw hole 107b, oblong slotted hole 201b, and screw hole 302b. FIG. 10D is a view of FIG. 10B, without the barrel bracket extension shown in FIG. 10B. In FIG. 10D, screw 109b similarly extends through screw hole 107b, oblong slotted hole 201b, and screw hole 302b. FIGS. 10C and 10D generally operate in the same or similar manner as FIGS. 10A and 10B.

FIG. 11 is an isometric view of an assembly of an interior side of a window 1106 that includes a frame 1102 fixed in the wall 1103, and a movable portion 1101 that is spanned by glass 1105. FIG. 11 shows the 1102 moveable portion 1101 of the window 1106 opened part-way by an extended actuator chain 104 coming from an actuator 1104 that is mounted on and recessed in the window frame 1102.

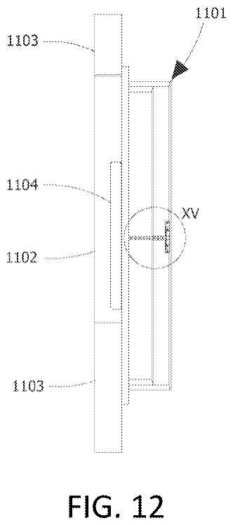

FIG. 12 is an elevation view of FIG. 11, viewed along arrow 12. The backside of the actuator 1104 is shown in the window frame 1102, with the actuator 1104 generally recessed in the window frame 1102. The window chain linkage 104e on an end of the actuator chain 104 is connected to the first barrel bracket 101a and the second barrel bracket 101b by fastener 105, as described above with regard to FIG. 1. As previously described, barrel brackets 101a, 101b are secured to the bracket 106 (not shown) when screws 109a, 109b are tightened. Bracket 106, in turn, is secured to the movable portion 1101 of the window 1106 by screws 110a, 110b through screw holes 108a, 108b of bracket 106.

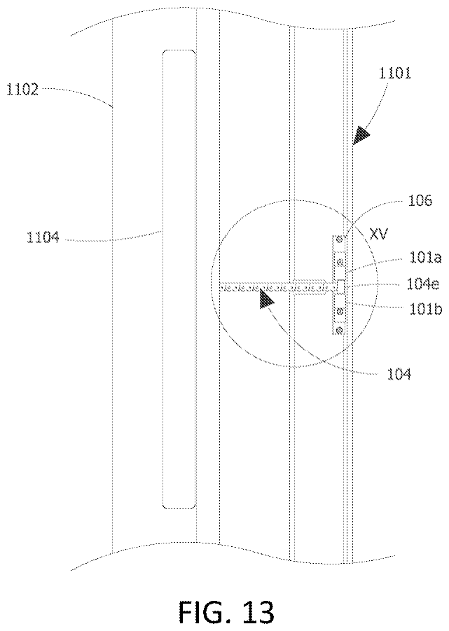

FIG. 13 is a magnified view of portion of FIG. 12, showing the side of moveable portion 1101 of window 1106, viewed along arrow 12 of FIG. 11. Barrel brackets 101a and 101b are connected to the bracket 106 fixed to the movable portion 1101 of the window 1106. Barrel bracket 101a is positioned on a first side of the window chain linkage 104e and barrel bracket 101b is positioned on an opposing side of the window chain linkage 104e. During installation, the window chain linkage 104e is inserted between the first barrel bracket 101a and the second barrel bracket 101b, and fastener 105 (such as a screw or pin), is inserted through the respective openings, such as a conventional bore hole, of the first barrel bracket 101a, the window chain linkage 104e, and the second barrel bracket 101b, such as in an analogous manner to the two leafs of a door hinge and the hinge pin that holds them together.

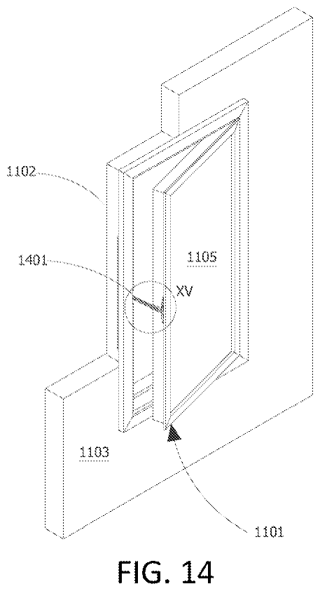

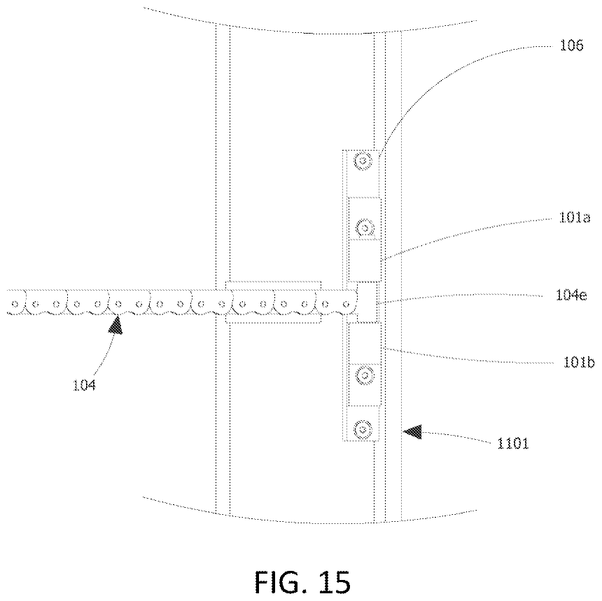

FIG. 14 is an isometric view of FIG. 11, rotated clockwise, showing the exterior side. Space 1401 is provided to receive the actuator linkage assembly 100 when the moveable portion 1101 of window 1106 is in a closed position. FIG. 15 is a close-up of the detail marked XV in FIGS. 11-14.

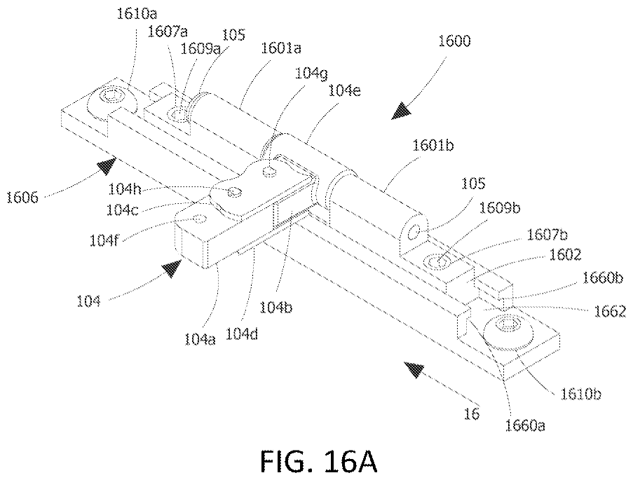

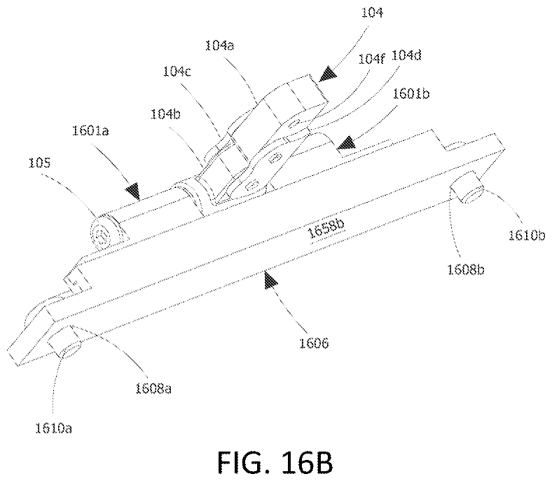

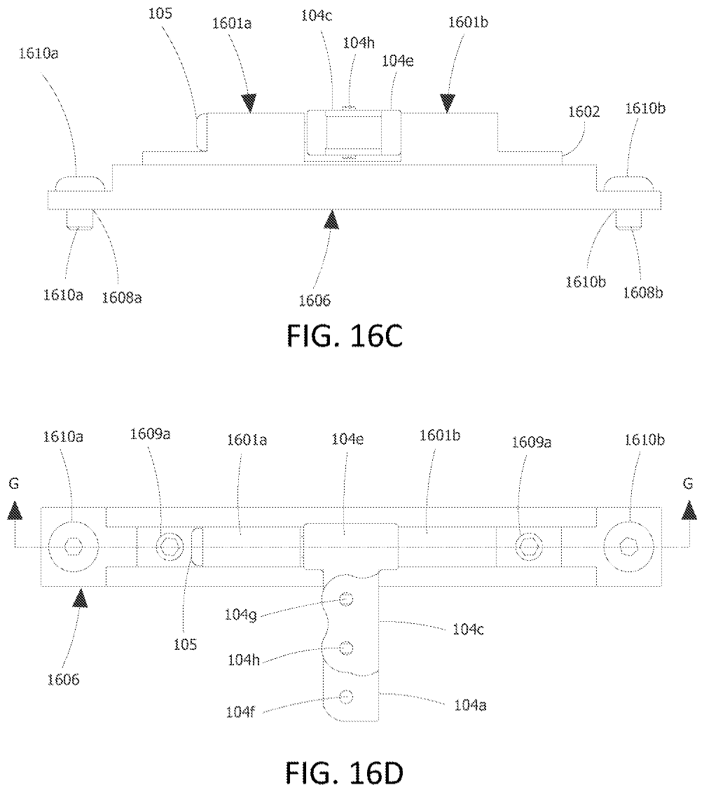

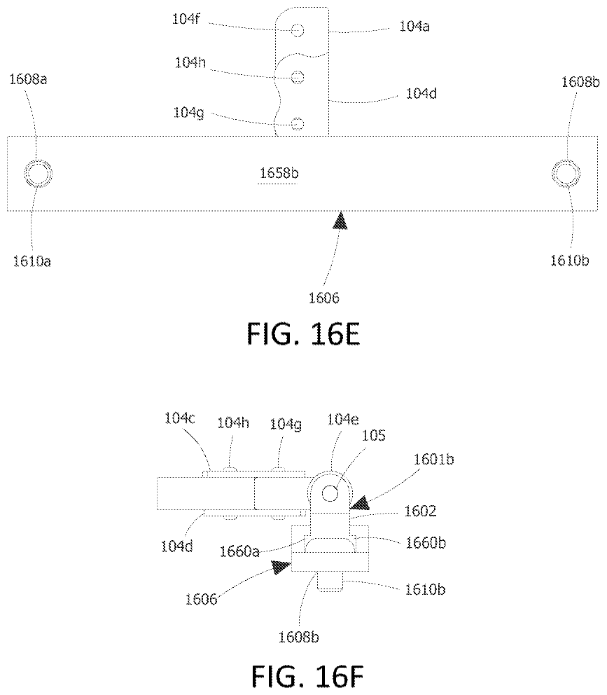

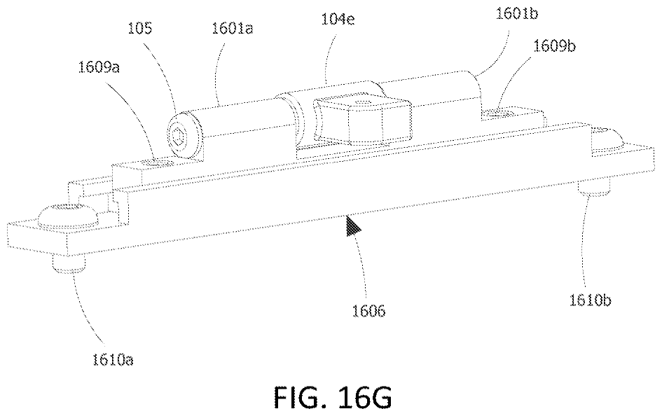

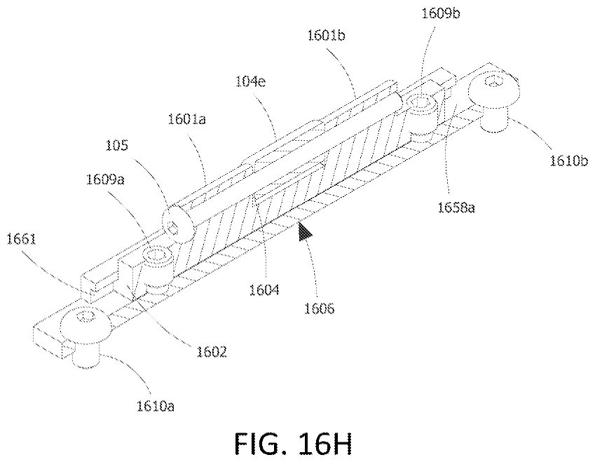

Referring to FIGS. 16A-16H, a second embodiment of an actuator linkage assembly 1600 is illustrated for connecting actuator chain 104 from a window actuator 1104 (shown in FIG. 11) to a movable portion 1101 of a window 1106 (shown in FIG. 11). More generally, it should be understood that the second embodiment depicted in FIGS. 16A-18E operate with FIGS. 11-15 in the same or substantially the same manner as the first embodiment depicted in FIGS. 1-10B.

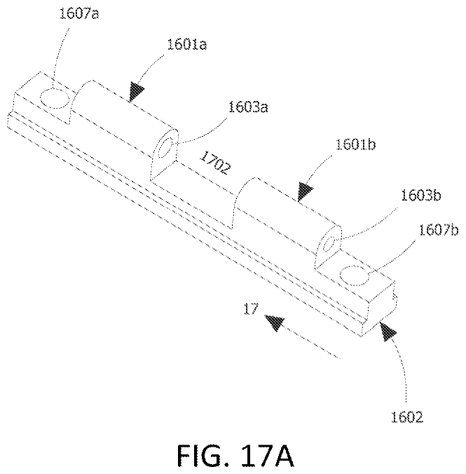

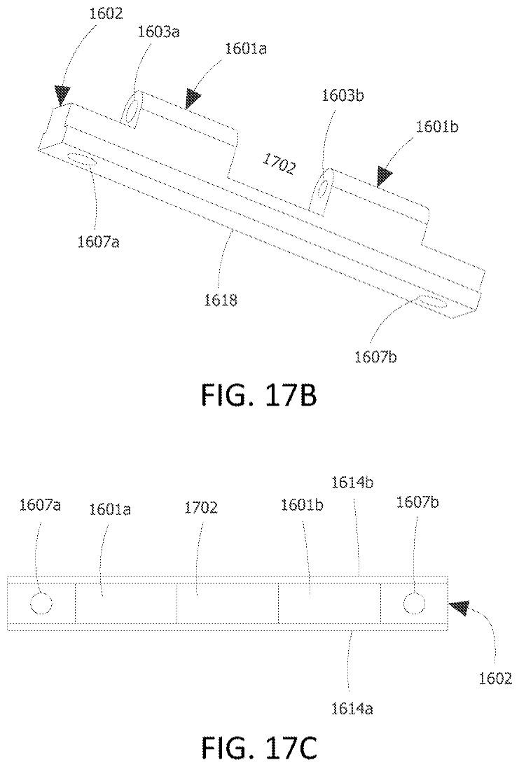

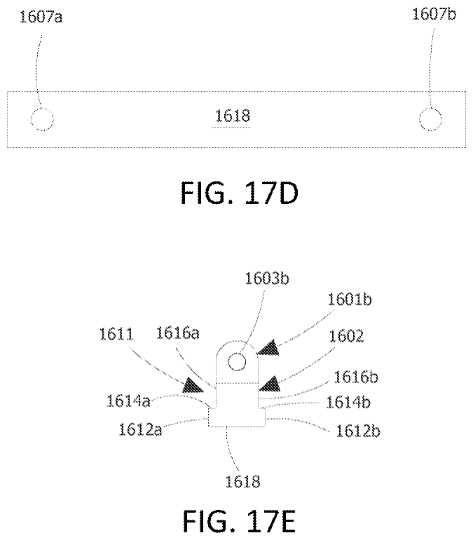

The actuator linkage assembly 1600 includes elements such as barrel brackets 1601a, 1601b that have openings 1603a, 1603b (shown in FIGS. 17A and 17B) to receive fastener 105, a T-shaped base 1602, and a slotted base bracket 1606 having an inner surface 1658a (shown in FIG. 16H) that slidably engages with the T-shaped base 1602 and is configured to fix the T-shaped base 1602 in a desired position along the length of the slotted base bracket 1606. As shown in FIG. 16B, the slotted base bracket 1606 has an outer surface 1658b for mounting to the moveable portion 1101 of window 1106 (as shown in FIG. 11).

A conventional window actuator 1104 (such as the KIMO 202 model by Nekos SRL, Colceresa (VI), Italy) having a conventional push-pull actuator chain 104, can be used to open and close the movable portion 1101 of window 1106, without having direct physical human contact with the window. The actuator chain 104 includes, for example, inner plates 104a, 104b, outer plates 104c, 104d, window chain linkage 104e, pinhole 104f, and pins 104g, 104h, which are conventional and part of the KIMO 202 actuator.

T-shaped base 1602 respectively includes screw holes 1607a, 1607b. Fasteners, such as screws 1609a, 1609b, are inserted through screw holes 1607a, 1607b to respectively fasten barrel brackets 1601a, 1601b in a desired position along the length of slotted base bracket 1606, as explained further herein. In addition, screws 1610a, 1610b are respectively inserted into screw holes 1608a, 1608b and tightened to secure the actuator linkage assembly 1600 to a moveable portion 1101 of window 1106, as shown, for example, in FIG. 11.

FIGS. 17A-17E illustrate various views of barrel brackets 1601a, 1601b. FIG. 17A shows that barrel brackets 1601a, 1601b include an opening 1702 into which the window chain linkage 104e is positioned. A width of opening 1702 can be sized to be slightly wider than a width of the window chain linkage 104e to thereby allow the window chain linkage 104e to be positioned within the opening 1702. In addition, as shown in FIG. 16H, barrel brackets 1601a, 1601b can also be sized to provide a clearance 1604 between barrel brackets 1601a, 1601b and window chain linkage 104e in order to allow the window chain linkage 104e to freely rotate about the fastener 105, in a same or substantially same manner as described above with regard to FIG. 6.

The barrel brackets 1601a, 1601b may be in the form of an elongate extrusion (for example, of aluminium or another suitable metal) which can be cut to a suitable length. In such an embodiment, the barrel brackets 1601a, 1601b may be formed as an integrally formed element, but it should be appreciated that variations, such as barrel brackets 1601a, 1601b which are formed from two or more parts, are within the scope of the present disclosure. FIGS. 17B and 17D show the bottom surface portion 1618 of barrel brackets 1601a, 1601b.

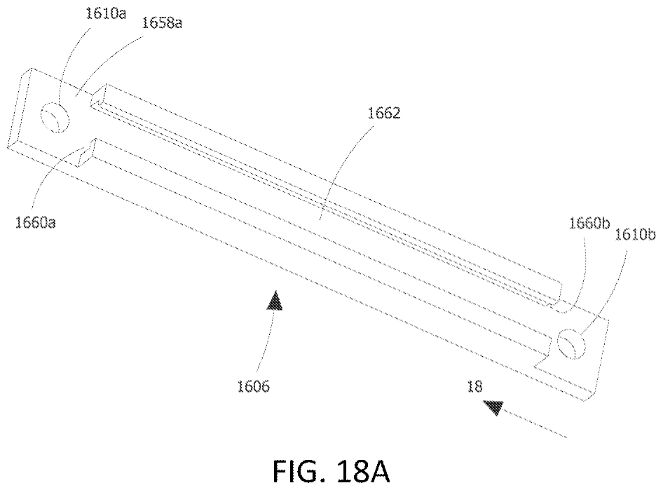

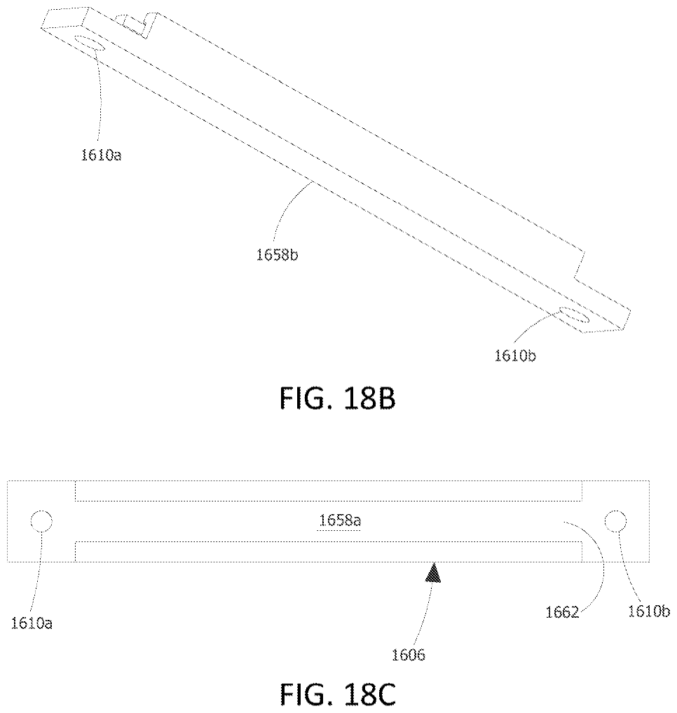

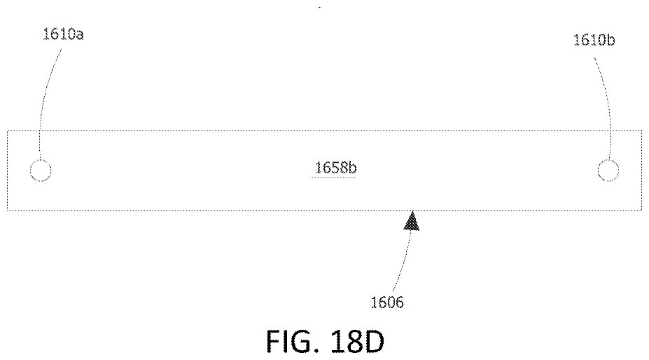

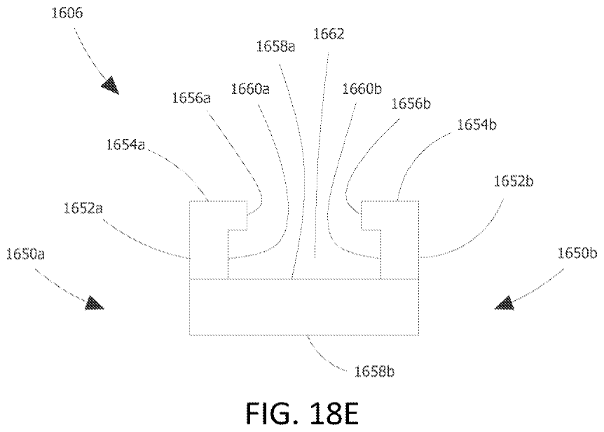

When window chain linkage 104e is positioned between the barrel brackets 1601a, 1601b, in opening 1702, the window chain linkage 104e and barrel brackets 1601a, 1601b are kept in alignment by fastener 105, which is inserted through a respective openings 1603a, 1603b, such as a conventional bore hole, of the first and second barrel brackets 1601a, 1601b, and an opening of the window chain linkage 104e, as shown in FIGS. 10B and 16H, such as in an analogous manner to the two leaves of a door hinge and the hinge pin that holds them together. Aspects of FIGS. 17A-17E are discussed further below in conjunction with FIGS. 18A-E.

FIGS. 18A-18E illustrate various views of slotted base bracket 1606. FIG. 18E is an end view of a slotted base bracket 1606 of FIG. 18A, looking along arrowed line 18 of FIG. 18A. The slotted base bracket 1606 may be in the form of an elongate extrusion (for example, of aluminium or another suitable metal) which can be cut to a length suitable for use for a particular opening. In such an embodiment, the slotted base bracket 1606 may be formed as an integrally formed element, but it should be appreciated that variations, such as elongate mounting members which are formed from two or more parts, are within the scope of the present disclosure.

The slotted base bracket 1606 has a first transverse side 1650a and a second transverse side 1650b, and an inner surface 1658a and an outer surface 1658b. The first transverse side 1650a includes a first wall 1652a that projects substantially perpendicularly away from the inner surface 1658a. The first wall 1652a terminates, along its edge distal from the inner surface 1658a, in a first return portion 1654a which extends away from first wall 1652a substantially towards the second transverse side 1650b of the slotted base bracket 1606.

The first wall 1652a and first return portion 1654a provide the first connection portion 1656a, which together define the first connection slot 1660a. The first connection slot 1660a is thus elongate and bounded in three of its transverse directions (e.g. left, top and bottom as seen in FIG. 18E) by the first wall 1652a, the first return portion 1654a, and part of the slotted base bracket 1606, while being open along its fourth transverse direction (e.g. right as seen in FIG. 18E) which faces the second transverse side 1650b of the slotted base bracket 1606.

Similarly, the second transverse side 1650b includes a second wall 1652b that projects substantially perpendicularly away from the inner surface 1658a. The second wall 1652b terminates, along its edge distal from the inner surface 1658a, in a second return portion 1654b which extends away from second wall 1652b substantially towards the first transverse side 1650a of the slotted base bracket 1606.

The second wall 1652b and second return portion 1654b provide the second connection portion 1656b, which together define the second connection slot 1660b. The second connection slot 1660b is thus elongate and bounded in three of its transverse directions (e.g. right, top and bottom as seen in FIG. 18E) by the second wall 1652b, the second return portion 1654b, and part of the slotted base bracket 1606, while being open along its fourth transverse direction (e.g. left as seen in FIG. 18E) which faces the first transverse side 1650a of the slotted base bracket 1606.

Thus, it will be appreciated that in this embodiment, the shapes of the first and second transverse sides 1650a, 1650b, are similar and generally symmetrical to each other, and spaced apart in the transverse width direction of the slotted base bracket 1606. The respective first and second connection slots 1660a, 1660b are also similar to each other and spaced apart in the transverse width direction of the slotted base bracket 1606.

Returning to FIG. 17E, the base 1611 includes bottom surface portion 1618 for engaging the inner surface 1658a of slotted base bracket 1606 (in FIG. 18E), a first side surface portion 1612a for approaching and possibly engaging the first wall 1652a (in FIG. 18E), a first return surface 1614a for approaching and possibly engaging the first return portion 1654a (in FIG. 18E), and first shoulder 1616a for approaching and possibly engaging the first connection portion 1656a. The base 1611 is dimensioned to fit closely in the first connection slot 1660a of FIG. 18E, and is thus in a form having surfaces for cooperation and engagement with corresponding surfaces of slotted base bracket 1606.

Base 1611 also includes a second side surface portion 1612b for approaching and possibly engaging the second wall 1652b (in FIG. 18E), a second return surface 1614b for approaching and possibly engaging the second return portion 1654b (in FIG. 18E), and second shoulder 1616b for approaching and possibly engaging the second connection portion 1656b. Base 1611 is dimensioned to fit closely in the first connection slot 1660a and second connection slot 1660b of FIG. 18E, and is thus in a form having surfaces for cooperation and engagement with corresponding surfaces of slotted base bracket 1606.

In operation, the T-shaped base 1602 of barrel brackets 1601a, 1601b is positioned within the cavity 1662 of slotted base bracket 1606, such as shown in FIGS. 16A, 18A, 18C and 18E. As shown generally in FIGS. 11-15, the actuator linkage assembly 1600 is mounted to a desired position of the moveable portion 1101 of window 1106 by tightening screws 1610a, 1610b, within the screw holes 1608a, 1608b (of slotted base bracket 1606), to secure the assembly 1600 to the moveable portion 1101. The T-shaped base 1602 slides within the cavity 1662 and is placed in a desired position within the cavity 1662. When the T-shaped base 1602 is placed in a desired position within the cavity 1662, screws 1609a, 1609b can be tightened within screw holes 1607a, 1607b.

As shown in FIG. 16H, when screws 1609a, 1609b are tightened within screw holes 1607a, 1607b, the T-shaped base 1602 moves toward the first connection portion 1656a and second connection portion 1656b. Particularly, a force is generated at the interface of the first return surface 1614a of the T-shaped base 1602 and the first connection portion 1656a of the slotted base bracket 1606, and at the interface of the second return surface 1614b of the T-shaped base 1602 and the second connection portion 1656b of the slotted base bracket 1606. Generally, as screws 1609a, 1609b are increasingly tightened, the force holding the T-shaped base 1602 in place correspondingly increases.

What is claimed is:

1. An actuator linkage assembly for mounting on a moveable portion of a window, comprising:
a first barrel bracket comprising a first opening;
a second barrel bracket comprising a second opening, wherein said first and second barrel brackets are capable of being arranged to have a window chain linkage comprising a third opening positioned between the first and second barrel brackets so that the first, the second and the third openings are in substantial axial alignment to receive a fastener for insertion into the first, second and third openings;
wherein the first barrel bracket comprises a first hole and the second barrel bracket comprises a second hole to respectively receive a first fastener and a second fastener;
a bracket comprising a first surface, a second surface and a third surface, the first and second surfaces comprising a first slot and a second slot, and the second and third surfaces forming a channel, wherein at least a portion of the first barrel bracket and at least a portion of the second barrel bracket contact at least a portion of the first surface;
wherein the first and second barrel brackets respectively comprise first and second extended portions that respectively fit into and slidingly engage along the first and second slots, and wherein the first and second extended portions respectively comprise a first hole and a second hole to respectively receive the first fastener and the second fastener;
a clamping plate positioned within the channel and in contact with the second surface, the clamping plate comprising a first hole and a second hole capable of respectively receiving the first fastener and the second fastener,
wherein the first barrel bracket is capable of being positioned along the first slot and secured in place by tightening the first fastener, and the second barrel bracket is capable of being positioned along the second slot and secured in place by tightening the second fastener, whereby positioning the first and second barrel brackets allows an actuator chain to be aligned along its length, from a fixed part of the window to the window chain linkage.

2. The actuator linkage assembly of claim 1, wherein the respective first holes of the first barrel bracket, the first extended portion, and the clamping plate, and the first slot of the bracket are in substantial alignment to receive the first fastener, and the respective second holes of the second barrel bracket, the second extended portion, and the clamping plate, and the second slot of the bracket are in substantial alignment to receive the second fastener.

3. The actuator linkage assembly of claim 1, wherein the first and second holes of the clamping plate are threaded.

4. The actuator linkage assembly of claim 1, wherein the first and second barrel brackets are capable of being secured in position when the first and second fasteners are tightened.

5. The actuator linkage assembly of claim 1, wherein the first and second slots are oblong.

6. The actuator linkage assembly of claim 1, wherein the bracket comprises a first hole configured to receive the first fastener and a second hole configured to receive the second fastener, for mounting the actuator linkage assembly to the moveable portion of the window.

7. The actuator linkage assembly of claim 1, wherein the actuator linkage assembly is capable of being configured to facilitate rotation of the moveable portion of the window, from a first position to a second position

8. The actuator linkage assembly of claim 1, wherein the actuator linkage assembly is capable of being further configured to facilitate opening and closing the moveable portion of the window.

9. The actuator linkage assembly of claim 1, wherein the fastener comprises a pin.

10. The actuator linkage assembly of claim 1, wherein the first and second oblong slots are positioned equidistant from a midpoint of the bracket.

11. The actuator linkage assembly of claim 1, wherein the actuator linkage assembly is capable of being configured to have a motor of an actuator facilitate extending and retracting the actuator chain to cause rotation of the moveable portion of the window, from a first position to a second position.

12. The actuator linkage assembly of claim 1, wherein the first fastener and the second fastener comprise a bolt.

13. An actuator linkage assembly for mounting on a moveable portion of a window, comprising:
a first barrel bracket comprising a first opening;
a second barrel bracket comprising a second opening, wherein said first and second barrel brackets are capable of being arranged to have a window chain linkage comprising a third opening positioned between the first and second barrel brackets so that the first, the second and the third openings are in substantial axial alignment to receive a fastener for insertion into the first, second and third openings;
a bracket comprising a first surface, a second surface and a third surface, the first and second surfaces comprising a first slot and a second slot, and the second and third surfaces forming a channel, wherein at least a portion of the first barrel bracket and at least a portion of the second barrel bracket contact at least a portion of the first surface;
a clamping plate positioned within the channel and in contact with the second surface, the clamping plate comprising a first hole configured to receive a first fastener inserted through a hole of the first barrel bracket and the first slot, and a second hole configured to receive a second fastener inserted through a hole of the second barrel bracket and the second slot,
wherein the first barrel bracket is capable of being positioned along the first slot and the second barrel bracket is capable of being positioned along the second slot, whereby positioning the first and second barrel brackets allows an actuator chain to be aligned along its length, from a fixed part of the window to the window chain linkage.

14. The actuator linkage assembly of claim 13, wherein the respective first holes of the first barrel bracket and the clamping plate, and the first slot of the bracket, are in substantial alignment to receive the first fastener, and the respective second holes of the second barrel bracket and the clamping plate, and the second slot of the bracket, are in substantial alignment to receive the second fastener.

15. The actuator linkage assembly of claim 13, wherein the first and second holes of the clamping plate are threaded.

16. The actuator linkage assembly of claim 13, wherein the first and second barrel brackets are capable of being secured in position when the first and second fasteners are tightened.

17. The actuator linkage assembly of claim 13, wherein the first and second slots are oblong.

18. The actuator linkage assembly of claim 13, wherein the bracket comprises a first hole configured to receive a first fastener and a second hole configured to receive a second fastener, for mounting the actuator linkage assembly to the moveable portion of the window.

19. The actuator linkage assembly of claim 13, wherein the actuator linkage assembly is capable of being configured to facilitate rotation of the moveable portion of the window, from a first position to a second position.

20. The actuator linkage assembly of claim 13, wherein the actuator linkage assembly is capable of being further configured to facilitate opening and closing the moveable portion of the window

21. The actuator linkage assembly of claim 13, wherein the fastener comprises a pin.

22. The actuator linkage assembly of claim 13, wherein the first and second oblong slots are positioned equidistant from a midpoint of the bracket.

23. The actuator linkage assembly of claim 13, wherein the actuator linkage assembly is capable of being configured to have a motor of an actuator facilitate extending and retracting the actuator chain to cause rotation of the moveable portion of the window, from a first position to a second position.

24. The actuator linkage assembly of claim 13 wherein the first fastener and the second fastener comprise a bolt.

25. A method for making an actuator linkage assembly for mounting on a moveable portion of a window suitable for use to align a chain of an actuator along a length of the chain between a fixed part of a window and a moveable portion of the window, comprising:
providing for use on the moveable portion of the window a first barrel bracket comprising a first opening;
providing for use on the moveable portion of the window a second barrel bracket comprising a second opening, wherein said first and second barrel brackets are capable of being arranged to have a window chain linkage connected to the chain and comprising a third opening, positioned between the first and second barrel brackets, wherein the first, second and third openings are capable of receiving a fastener for insertion into the first, second and third openings;
providing a bracket comprising a first surface and a second surface comprising a first slot and a second slot, wherein at least a portion of the first barrel bracket and at least a portion of the second barrel bracket are capable of being positioned to contact at least a portion of the first surface;
providing a clamping plate capable of being positioned within a channel of the bracket and in contact with the second surface, the clamping plate comprising a first hole configured to receive a first fastener inserted through a hole of the first barrel bracket and the first slot, and a second hole configured to receive a second fastener inserted through a hole of the second barrel bracket and the second slot, so that the chain is capable of being maintained in alignment along its length, from the fixed part of the window to the window chain linkage, upon mounting the bracket to the moveable portion of the window and securing the first barrel bracket along the first slot and the second barrel bracket along the second slot by respectively tightening the first and second fasteners.

26. The method of claim 25, further comprising providing on the first and second barrel brackets an extended portion that respectively fits into the first and second slots.

27. The method of claim 25, wherein the first and second slots are oblong.

28. The method of claim 25, further comprising providing the bracket with a first hole configured to receive a first fastener and a second hole configured to receive a second fastener for mounting the actuator linkage assembly to the moveable portion of the window.

29. The method of claim 25, further comprising providing the actuator linkage assembly with the capability of being configured to facilitate rotation of the moveable portion of the window, from a first position to a second position.

30. The method of claim 29, further comprising providing the actuator linkage assembly with the capability of rotating the moveable portion of the window from a first position to a second position without binding the actuator chain.

31. The method of claim 29, further comprising providing the actuator linkage assembly with the capability of being configured to facilitate opening and closing the moveable portion of the window.

32. The method of claim 31, further comprising providing the actuator linkage assembly with the capability of being configured to facilitate opening and closing the moveable portion of the window, without binding the actuator chain.

33. The method of claim 25, wherein the fastener comprises a pin.

34. The method of claim 25, wherein the first and second oblong slots are positioned equidistant from a midpoint of the bracket.

35. The method of claim 25, further comprising providing the actuator linkage assembly with the capability of being configured to have a motor facilitate extending and retracting the actuator chain to cause rotation of the moveable portion of the window, from a first position to a second position.

36. The method of claim 25, further comprising providing a first screw as the first fastener and a second screw as the second fastener.

37. The method of claim 25, further comprising providing the actuator chain linkage assembly with the capability of being configured to be driven by an actuator motor of an actuator mounted on or within the fixed portion of the window, to cause the actuator chain to extend from the actuator and retract into the actuator, to thereby rotate the moveable portion of the window, from a first position to a second position.

38. The method of claim 25, further comprising providing the bracket with a first hole configured to receive a first fastener and a second hole configured to receive a second fastener for mounting the actuator linkage assembly to the moveable portion of the window.

39. The method of claim 25, wherein the first and second holes of the clamping plate are threaded.

40. A method for connecting an actuator chain extending from a fixed part of a window to a moveable portion of the window, comprising:
providing for use on the moveable portion of the window a first barrel bracket comprising a first opening;
providing for use on the moveable portion of the window a second barrel bracket comprising a second opening, wherein the first and second barrel brackets are capable of being arranged to have a window chain linkage connected to the chain and comprising a third opening capable of being positioned between the first and second barrel brackets, wherein the first, second and third openings are capable of receiving a fastener for insertion into the first, second and third openings;
providing a bracket comprising a first surface and a second surface, said first and second surfaces comprising a first slot and a second slot, wherein at least a portion of the first barrel bracket and at least a portion of the second barrel bracket are capable of being positioned to contact at least a portion of the first surface, whereby positioning the first and second barrel brackets allows an actuator chain to be aligned along its length, from the fixed part of the window to the window chain linkage; and
providing a clamping plate capable of being positioned within a channel of the bracket and in contact with the second surface, the clamping plate comprising a first hole configured to receive a first fastener inserted through a hole of the first barrel bracket and the first slot, and a second hole configured to receive a second fastener inserted through a hole of the second barrel bracket and the second slot, wherein the first barrel bracket is capable of being secured along the first slot and the second barrel bracket is capable of being secured along the second slot by respectively tightening the first and second fasteners.

41. The method of claim 40, wherein the chain is capable of being maintained in alignment along its length, from the fixed part of the window to the window chain linkage, upon securing the first barrel bracket along the first slot and securing the second barrel bracket along the second slot by respectively tightening the first and second fasteners.

42. The method of claim 40, further comprising providing on the first and second barrel brackets an extended portion that respectively fits into the first and second slots.

43. The method of claim 40, wherein the first and second slots are oblong.

44. The method of claim 40, further comprising providing the bracket with a first hole configured to receive a first fastener and a second hole configured to receive a second fastener for mounting the bracket to the moveable portion of the window.

45. The method of claim 40, further comprising providing the first and second barrel brackets with the capability of being configured to facilitate rotation of the moveable portion of the window, from a first position to a second position.

46. The method of claim 45, further comprising providing the first and second barrel brackets with the capability of being configured to facilitate rotation of the moveable portion of the window without binding the actuator chain.

47. The method of claim 40, further comprising providing the actuator linkage assembly with the capability of being configured to facilitate opening and closing the moveable portion of the window.

48. The method of claim 47, further comprising providing the actuator linkage assembly with the capability of being configured to facilitate opening and closing the moveable portion of the window, without binding the actuator chain.

49. The method of claim 40, wherein the fastener comprises a pin.

50. The method of claim 40, wherein the first and second oblong slots are positioned equidistant from a midpoint of the bracket.

51. The method of claim 40, further comprising providing the actuator chain linkage assembly with the capability of being configured to be driven by an actuator motor of an actuator mounted on or within the fixed portion of the window, to cause the actuator chain to extend from the actuator and retract into the actuator, to thereby rotate the moveable portion of the window, from a first position to a second position.

52. The method of claim 40, further comprising providing a first screw as the first fastener and providing a second screw as a second fastener.

53. The method of claim 40, further comprising providing the actuator linkage assembly with the capability of being configured to have a motor facilitate extending and retracting the actuator chain to cause rotation of the moveable portion of the window, from a first position to a second position.

54. The method of claim 40, wherein the first and second barrel brackets are capable of being secured in position along the bracket when the first and second fasteners are tightened.

55. The method of claim 40, wherein the first and second holes of the clamping plate are threaded.

56. A window actuator linkage assembly for mounting on a moveable portion of a window, comprising:
an elongate mounting member having a first barrel bracket and a second barrel bracket separated from the first barrel bracket by an opening along a length of the elongate mounting member, and a base portion having i) a bottom surface portion, ii) a first side surface portion extending substantially perpendicular from the bottom surface portion, iii) a first return surface extending substantially perpendicular from the first side surface portion, iv) a first shoulder extending substantially perpendicular from the first return surface, v) a second side surface portion extending substantially perpendicular from the bottom surface portion and substantially parallel to the first side surface portion, vi) a second return surface extending substantially perpendicular from the second side surface, and vii) a second shoulder extending substantially perpendicular from the second return surface and substantially parallel to the first shoulder, wherein a width of the bottom surface portion defined by the first and second side surface portions is greater than a width of the first and second barrel brackets; and
an elongate base bracket, formed separately from and configured to be secured to the elongate mounting member, having i) an inner surface and an outer surface, ii) a first wall extending substantially perpendicularly from and along a first edge of the inner surface, terminating at a first wall edge distal from the first edge of the inner surface, iii) a second wall projecting substantially perpendicularly from and along a second edge of the inner surface and substantially parallel to the first wall, terminating at a second wall edge distal from the second edge of the inner surface, iv) a first return portion extending from the first wall edge and substantially towards the second wall, and v) a second return portion extending from the second wall edge and substantially towards the first wall,
wherein the first side surface portion is configured to be slidably positioned along the first wall and the first return surface is configured to be slidably positioned along the first return portion, and
wherein the second side surface portion is configured to be slidably positioned along the second wall and the second return surface is configured to be slidably positioned along the second return portion.

57. The assembly of claim 56, wherein the base portion further comprises at least one hole.

58. The assembly of claim 56, wherein the at least one hole is configured to receive a screw to fasten barrel brackets in a desired position along the length of the elongated base bracket.

59. The assembly of claim 56, wherein the base portion further comprises at least two holes.

60. The assembly of claim 56, wherein the at least two holes are configured to respectively receive a screw to fasten barrel brackets in a desired position along the length of the elongated base bracket.

61. The assembly of claim 56, wherein the elongate base bracket further comprises at least two screw holes.

62. The assembly of claim 56, wherein the at least two screw holes are configured to respectively receive a screw to fasten the elongate base bracket to the moveable portion of the window.

63. The assembly of claim 56, wherein the opening is configured to receive a window chain linkage of an actuator.

64. The assembly of claim 63, wherein the window chain linkage 104e comprises a third opening.

65. The assembly of claim 64, wherein the first, second and third openings are capable of receiving a fastener for insertion into the first, second and third openings.
